(19) United States
(12) Patent Application Publication
(10) Pub. No.: US 2020/0274846 A1
(43) Pub. Date: Aug. 27, 2020

(54) MULTI-MESSAGING

(71) Applicant: Avenshare LLC, Valley Cottage, NY (US)

(72) Inventors: Michael Palandro, Valley Cottage, NY (US); Chris Wiggerman, Valley Cottage, NY (US)

(73) Assignee: Avenshare LLC, Valley Cottage, NY (US)

(21) Appl. No.: 16/283,160

(22) Filed: Feb. 22, 2019

(51) Int. Cl. H04L 12/58; H04M 1/725; G06F 16/9535

(52) U.S. Cl. CPC H04L 51/36; H04M 1/72552; G06F 16/9535; H04L 51/20; H04L 51/16; H04L 51/32

(57) ABSTRACT

A multi-messaging information sharing platform is presented for use on a personal electronic device. The information sharing platform may have a mobile application stored within the memory of the personal electronic device. The mobile application can have an integration architecture in which the internal components of the personal electronic device may be able to access a secondary application. A common multi-messaging screen may be present providing a user an interface in which the user can access the secondary application through the mobile application of the information sharing platform

### FIELD OF DISCLOSURE

The present disclosure generally relates to an information sharing platform, and more particularly relates to providing a mobile application for accessing, transmitting, and retaining communications and information between registered contacts.

### BACKGROUND OF THE DISCLOSURE

Information sharing services may connect multiple users to one another. To access and communicate through these services a user must first obtain the information sharing service through either a downloadable program or application or through a contract allowing a user to access a dedicated network. Communication over these information sharing services is typically specific and restrictive to the employed information sharing service. For example, in the past, telephones were the primary communication options for users to contact one another. To obtain access to a telephone a user would have to first purchase a telephone device and then enter into a contractual agreement with a telephonic service provider to access the network allowing the telephone user to contact other parties.

However, as modern technology has advanced information sharing services have greatly multiplied. Personal users can no longer be confident that one specific information sharing service would be adequate to connect each and every personal or business contact and individual may have. In modern times other informational sharing services, such as email provides, social networking, and social media and communication application are now common place. To access members belonging to a specific information sharing service a user must only communicate through that specific information sharing service.

Therefore, it would be advantageous to develop an information sharing platform which would connect all the contacts for a user which may be contained in separate informational sharing services. Additionally, it would be advantageous that the provided platform would have a common transmission and receiving feature so that all messages sent and received by the multiple information sharing services would be collected and maintain within a common accessible location.

### SUMMARY OF THE DISCLOSURE

In accordance with one aspect of the disclosure, an information sharing platform is presented for exchanging information between users. The information sharing platform may have a mobile application. The mobile application being a non-transitory storage medium stored within the memory of a personal electronic device of a user. A secondary application may also be stored within the memory of the personal electronic device of the user. A present integration architecture is able to access the memory and internal components of the personal electronic device and connect the secondary application to be accessed with the mobile application. Also, a common multi-messaging screen may be present. The common multi-messaging screen provides the user an interface upon which the user may send and receive information through either the mobile application or the secondary application by accessing the internal components of the personal electronic device to send and receive such information.

In accordance with another aspect of the disclosure, an information sharing platform is presented for exchanging information between users. The information sharing platform may have a mobile application. The mobile application being a non-transitory storage medium stored within the memory of a personal electronic device of a user. A secondary application may also be stored within the memory of the personal electronic device of the user. A present integration architecture is able to access the memory and internal components of the personal electronic device and connect the secondary application to be accessed with the mobile application. A connectivity architecture may be configured to use name identification for a communication between users, and the connectivity architecture may be configured to direct and display the communication by a contact list of the user. Also, a common multi-messaging screen may be present. The common multi-messaging screen provides the user an interface upon which the user may send and receive information through either the mobile application or the secondary application by accessing the internal components of the personal electronic device to send and receive such information.

These and other aspects and features will be better understood when taken in conjunction with the following drawings.

### BRIEF DESCRIPTION OF THE DRAWINGS

FIG. 1 is a schematic view of the internal components of a personal electronic device constructed in accordance with an embodiment of the present disclosure.

FIG. 2 is a bubble view of an information sharing platform accessible by a personal electronic device in accordance with an embodiment of the present disclosure.

FIG. 3 is a flow diagram depicting a direct synchronization of the information sharing platform with a remote server in accordance with an embodiment of the present disclosure.

FIG. 4 is a flow diagram depicting a multi-messaging selector of the information sharing platform in accordance with an embodiment of the present disclosure.

FIG. 5 is a modified flow diagram depicting the search function of the information sharing platform in accordance with an embodiment of the present disclosure.

It should be understood that the drawings are not necessarily to scale and that the disclosed embodiments are illustrated diagrammatically and in partial views. It should be further understood that this disclosure is not to be limited to the particular embodiments illustrated herein.

### DETAILED DESCRIPTION OF THE DISCLOSURE

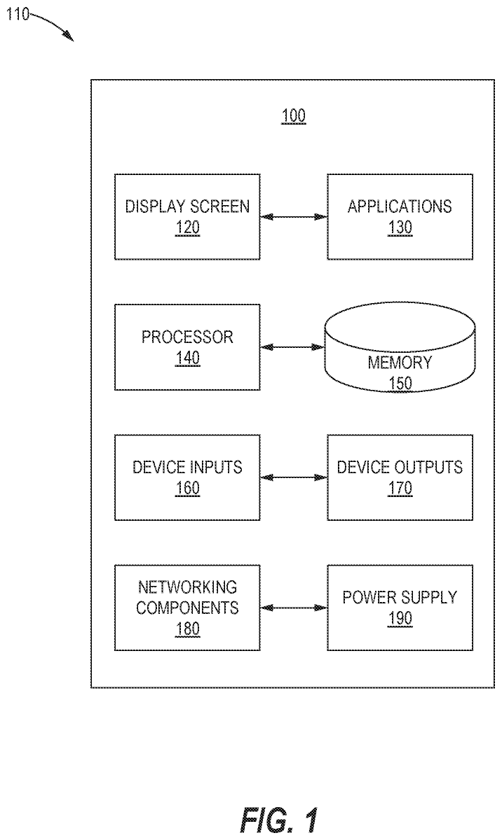

Referring now to FIG. 1, a personal electronic device 100 is depicted upon which the disclosed information sharing platform 110 can be stored and accessed. In the illustrated embodiment, the components of the personal electronic device 100 include a display screen 120, applications (e.g., programs) 130, a processor 140, a memory 150, one or more device inputs 160, and one or more device outputs 170. The personal electronic device 100 may be a mobile device, such as a smartphone, a laptop computer, a tablet computer (or pad), an electronic book (eBook reader, or other mobile or personal electronic devices that may be used to communicate wirelessly (or via a fixed link) and allow the user to view and share information. Moreover, the personal electronic device 100 may also be any computer, such as a desktop computer, or processor based device that may use fixed (or wireless) links to communicate with other components and devices.

The display screen 120 may be connected to the processor 140 and memory 150 of the personal electronic device 100. When a user accesses the personal electronic device 100, the display screen 120 may visually represent the encoded software of the operating system of the personal electronic device 100 saved within the memory 150. Additionally, the display screen 120 may visually show the applications 130 accessed by the user which also may be stored within the memory 150 of the personal electronic device 100. The display screen 120 may have the added benefit of being operable as a device input 160. As a device input 160 the display screen 120 may respond to the touch of a user or a stylus to allow the user to input information into the personal electronic device 100 regarding the operation of programs or applications 130 stored within the personal electronic device 100. Additionally, as a device input 160, the display screen 120 may be able to scan and recognize a user's fingerprints, if a user places their finger within a certain portion of the display screen 120 for recognition and input.

The processor 140 can be any of a microprocessor, microcomputer, application-specific integrated circuit, or the like. For example, the processor 140 can be implemented by one or more microprocessors or controllers within an integrated circuit design. Similarly, the memory 150 may reside on the same integrated circuit as the processor 140. The memory 150 may include a random access memory (i.e., Synchronous Dynamic Random Access Memory (SDRAM), Dynamic Random Access Memory (DRAM), RAMBUS Dynamic Random Access Memory (RDRM) or any other type of random access memory device or system). Additionally or alternatively, the memory 150 may include a read only memory (i.e., a hard drive, flash memory or any other desired type of memory device).

The information that is stored by the memory 150 can include program code associated with one or more operating systems or applications 130 as well as informational data. Although the memory 150 is usually located locally within the personal electric device 100, the memory 150 may be accessed by the networking components 180 if it is located remotely on a network server or cloud based computing component. The operating system and applications 130 are typically implemented via executable instructions stored in a non-transitory computer readable medium within the memory 150 to control basic functions of the personal electronic device 100. These functions may include interaction among various internal components of the personal electronic device 100 and storage and retrieval of applications 130 and data to and from the memory 150.

With respect to the applications 130 stored within the memory 150, these typically utilize the operating system to provide more specific functionality. In an embodiment of the present disclosure, the information sharing platform 110 may be a mobile application located within the memory 150 of the personal electronic device 100. Many applications 130 stored within the memory 150 may provide standard or required functionality of the personal electronic device 100. However, in other cases applications 130 such as the information sharing platform110 of the disclosure provide optional or specialized functionality, and may be supplied by third party vendors.

As stated above the personal electronic device 100 may have a device input 160 and a device output 170. Examples of the device input 160 and device output 170 may include a touch screen or a physical keyboard, a stylus, a microphone, a camera, a speaker, wireless interface, infrared interfaces, and/or other input/output interfaces which may be present on the personal electronic device 100. A user may input information through the device input 160 which would then be sent to the processor 140 and memory 150 to execute the inputted information. Furthermore, the device output 170 may produce the required output, either visually or audibly, dependent on the execution of the applications 130 or commands executed by the processor 140 of the personal electronic device 100.

Furthermore the personal electronic device 100 may include software and hardware networking components 180 to allow communications to and from the personal electronic device 100. The personal electronic device 100 may have one or more wireless access technologies or interfaces, such as a chip or component, to enable the personal electronic device 100 to establish a fixed or wireless link to an outside network. Additionally, the personal electronic device 100 may have one or more wireless technology interfaces that may communication with one or more of the other components of the personal electronic device 100. The wireless technologies and interfaces that may be used by the corresponding components of the personal electronic device 100 may include a Bluetooth interface, and Institute of Electrical or Electronic Engineers (IEEE) 802.11 compliant (or Wi-Fi) wireless interface, a near field communication (NFC) link, an Infrared Data Association interface, a Radio-Frequency identification interface or a radio frequency transponder, a reflection antenna chip, cellular interface, and or any other wireless technology interface that may be applicable to the personal electronic device. These networking components 180 provide wireless networking functionality, although wired networking may additionally or alternatively be supported.

Moreover, a power supply 190, such as a battery or fuel cell, may be included for providing power to the personal electronic device 100 and its components. All or some of the internal components communicate with one another by way of one or more shared or dedicated internal communication links 195, such as an internal bus. Through these internal communication links 195, power and data may be shared between the multiple internal components of the personal electronic device 100.

In an operational setting, the personal electronic device 100 is programmed such that the processor 140 and memory 150 interact with the other components of the personal electronic device 100 to perform a variety of functions. The processor 140 may communicate with the memory 150 to implement various modules and execute programs for different activities such as launching an application, transferring data, and toggling through various graphical user interface objects representing thumbnail images of executable programs stored within the memory 150.

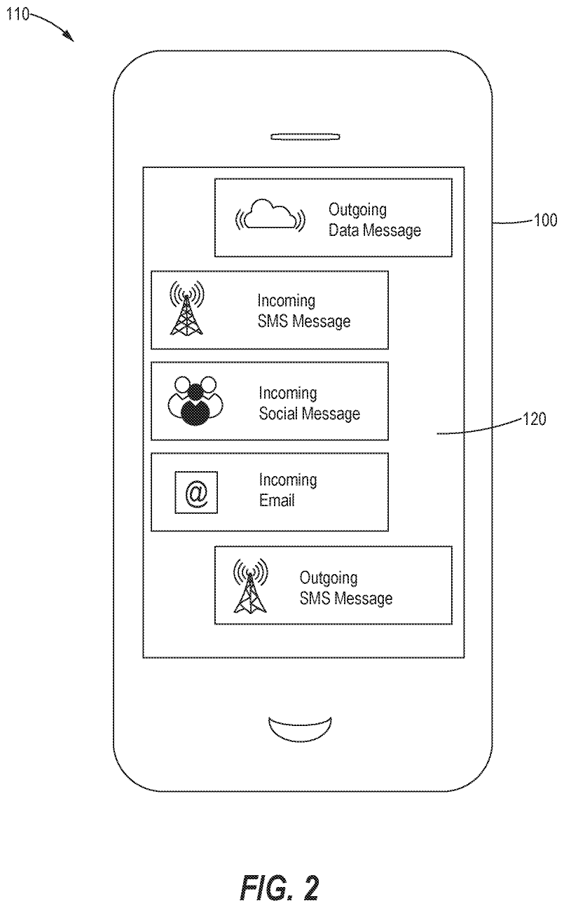

Referring now to FIG. 2, the information sharing platform 110 is depicted on the display screen 120 of the personal electronic device 100. The information sharing platform 110 as stated above may be a mobile application 130. The information sharing platform 110 may have a multitude of modules expressing four key areas of functionality: News/Social; Camera; Photo Edit and Messaging. Each of these modules may include geographical location from within the context of a conversation being held within the information sharing platform 110. All functions are integrated through recognition of entities listed in the users' contact list within the information sharing platform 110. These entities can be comprised of either individuals, groups of individuals, businesses, or other miscellaneous types of contacts a user may have listed in their contact list. Communication interactivity is displayed on the personal electric device of a user for each respective contact or group. The communication interactivity may be displayed by means of a bubble view on the information sharing platform 110. The bubble view is descriptively named for the window that displays the messages in bubble format. The bubble view respectively shows all interactions with a contact in chronological order from first to last, with the last interaction received from that contact shown first. All contact interactions are maintained in this manner on the personal electronic device of the user until deleted.

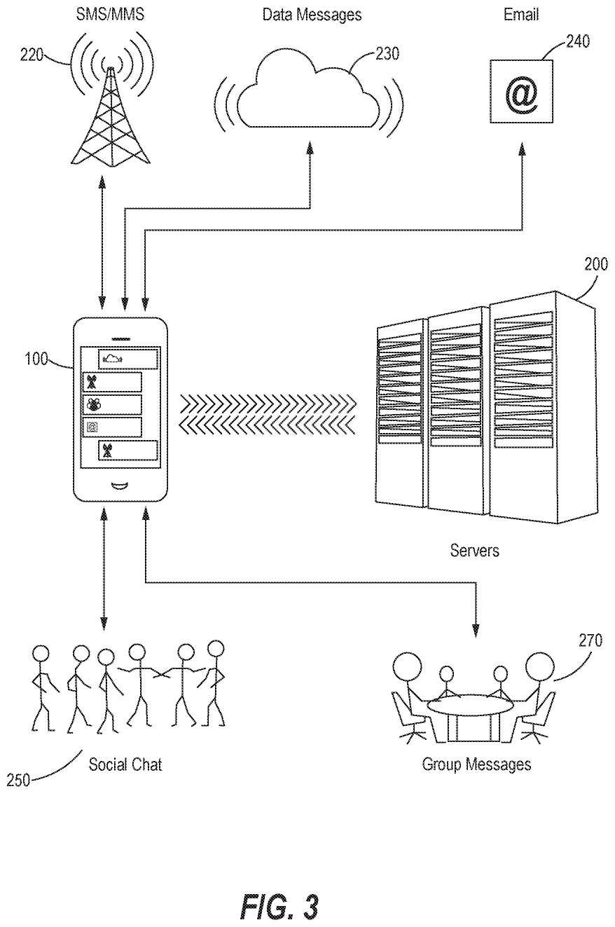

Referring now to FIG. 3, the interactions with the contact also are shown in the same capacity and manner through the information sharing platform's 110 functionality connection to a remote server 200. This remote server 200 may include a web based portal allowing the user to enter a designated website. Connection to the remote server 200 allows direct synchronization between the information sharing platform 110 on the user's personal electronic device and/or their desk top, laptop or PC tablet. The message, photo or e-mail interactions, although deleted from a user's personal electric device can remain stored on your computer device of choice or most appropriately on the remote server. This form of functionality is unique to the information sharing platform 110 and is not found as part of any other platform which may accommodate similar types of mobile interactivities between connected users.

What makes the information sharing platform 110 unique and differentiates it from any of the other connectivity platforms currently on the market, is that other connectivity platforms only provide some of the functions that the information sharing platform 110 offers as part of its complete platform. None of the other connectivity platforms offer the level of comprehensiveness or communication options provided through the information sharing platform 110. Especially since all of information sharing platform's 110 communication interactions between users is logically and conveniently directed and displayed by contact names By using contact name identification for communicating, this precludes trying to remember a phone number, email address or social contact name, etc. The information sharing platform's 110 usage of contact name connectivity provides a state of the art user friendly natural and easily understandable solution, in place of the other alternative solutions currently being used today.

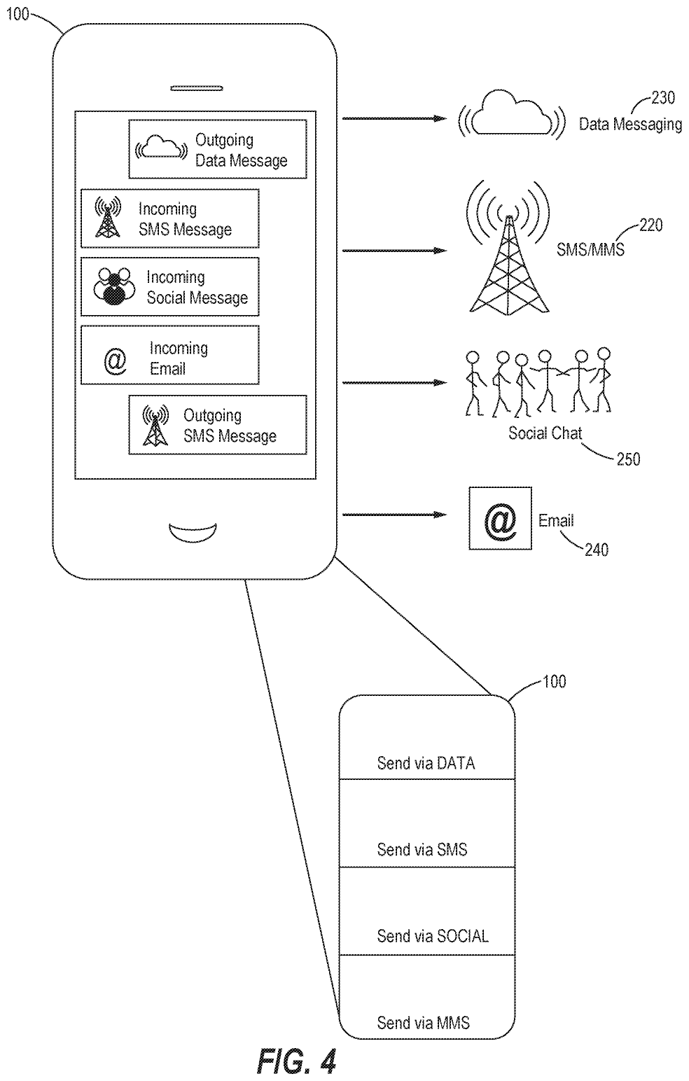

Referring now to FIG. 4, with continued reference to FIGS. 1-3, the information sharing platform 110 employs a direct interface and use of the users' respectively recognized contacts incorporated by other mobile applications through its functionality. This type of functionality may be provided within a multi-messaging slide selector 210. This important aspect emphasizes user friendliness in that the user is not stymied by having to switch from one mobile application to another in order to go from texting, to multimedia function, to social chatting, to data messaging, to sending a photo, or to e-mailing. These functions and more, as will be further explained in more detail, are all included as standard features as part of the information sharing platform's 110 functionality.

Connectivity between users is the primary application used by the overwhelming population of mobile device users. This fact is evident by the number of mobile applications available that offer a means for one or more individuals or groups to interact with other individuals or groups through various means of mobile connectivity.

Therefore, the comprehensively inclusive messaging aspects uniquely provided by the information sharing platform 110 ensure multiple means of connectivity through: SMS (Short Messaging Service) and MMS 220 (Multimedia Service); Internet Push 230 (GCM-Google Cloud Messaging and Data Transfer); e-mail 240; and News/Social 250, through the information sharing platform's 110 social network platform; which also allows SMS and

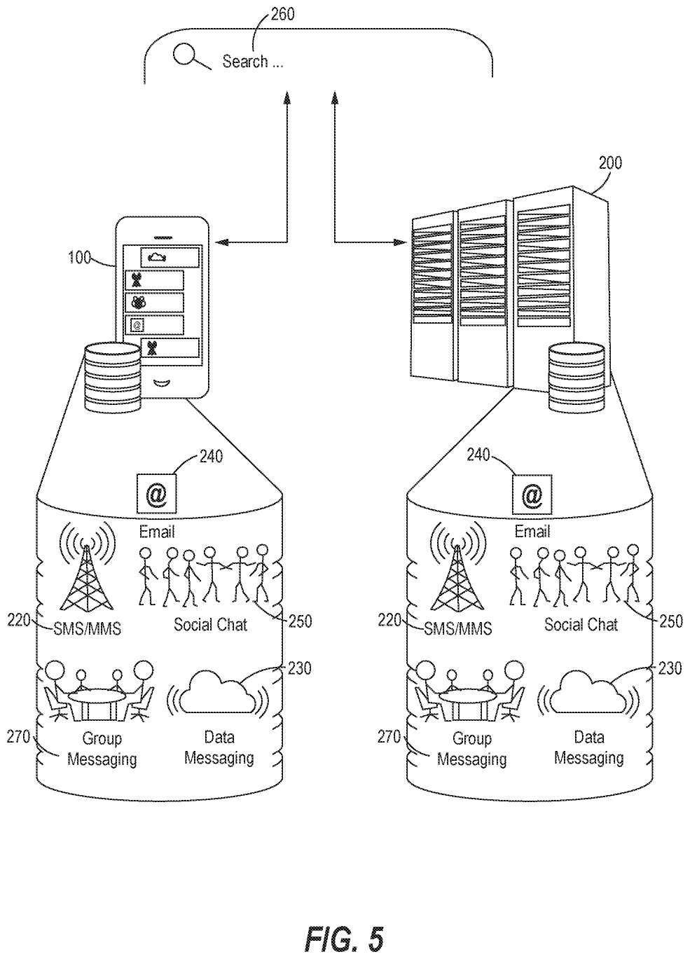

MMS 220 to correspond through a user's home PC. And, as previously noted, the information sharing platform 110 can provide storage for communication activity no longer wanted on the users' mobile phone. The users' communication interactions with other connected users will be maintained and displayed in the same format, by user contact, and chronology on their other computer equipment of choice, in the same manner displayed on the user's personal mobile device. This is especially important in groups to allow the user to be able to read all the group messages 270 (FIG. 5) in one single conversation, rather than having to jump between multiple conversations while keeping track of the chronological order to follow what the group is conversing about.

Once again, this unique connectivity is all readily accomplished using identification with the users' contact list information; that is already organized and stored in the user's personal electronic device 100. The user's contact list information is automatically uploaded to the information sharing platform 110 once the information sharing platform 110 is downloaded onto the user's personal electronic device. New contacts will be automatically added into information sharing platform 110 when the user corresponds with the new contact. It should be noted that if an outsider contacts a user employing the information sharing platform 110, it does not trigger any specific communication event other than the message being received. Upon such correspondence the new contact will be automatically prompted to download the information sharing platform 110 to their mobile device to become an active part of the information sharing platform's 110 functionality and to receive the benefits of using the information sharing platform 110.

The messaging service that the information sharing platform 110 providing is a multi-messaging service. Within the multi-messaging service, all of the information sharing platform's 110 messaging is performed through a unified inbox/outbox program. This maintains all messaging, recognized by the information sharing platform 110 offering, irrelevant of type, to be recognized by user contact through use of and completely integrated by the aforementioned bubble view. All messaging is organized and displayed by user contact, in one easy to negotiate user friendly format. This eliminates the need to jump from one distinct mobile application to another mobile application in order to accommodate a respective message reply to that contact. The information sharing platform 110 will only reply using data messaging since it is free and converted to SMS 220 if needed in the case the sender does not have the information sharing platform 110 installed. This is a revolutionary function that will change the way contacts will correspond with each other in the near future through the use of the information sharing platform 110.

In addition, as previously stated, the information sharing platform 110 provides a web portal, which presents the social network, chat platform of the information sharing platform 110; that can be domiciled on the users' home or other PC device. The uniqueness of these two associated activities represent an ability to view and communicate through means of text messaging(SMS) and data messaging(MMS), not only through the users personal electronic device but also from their desktop computer or laptop computer or PC tablet.

The information sharing platform 110 has been able to harness the two vastly different types of communication; one conducted through the internet (e-mail and social networking) and the other through the users' local carrier (texting, multi-media messaging and data transfer/GCM messaging) and to effectively combine them in like fashion as part of one mobile application. This combination of communication activities provides a powerful formula for the most comprehensive platform available on the market today. No other mobile application currently offers complete synchronization between mobile and home PC option to the user.

As part of the information sharing platform's 110 industry leading communication interactivity offered between connected users; it also provides state of the art photo editing, downloading and transfer functions. The information sharing platform 110 provides an unmatched variety and multitude of photo filters and photo editing functions likened to a professional level, to provide expert photographic skills with the ease of application and conducted as simple as a touch. In addition, the information sharing platform 110 will also offer this photographic quality level of editing at full resolution for download and transfer of photos, allowing for the highest quality photos, whether for display or to print, a function not currently offered by the majority of other photo editing mobile apps. As a user you will not be subjected to constantly having to provide quality edit adjustment to your photos by having to search for and ultimately use other apps. The information sharing platform's 110 easy to use advanced photo edit functions will seamlessly initiate the most user friendly and fastest way to handle any user's photo editing and full resolution requirements.

In addition, to the information sharing platform's 110 exceptional and unrivaled photo editing capabilities, the information sharing platform 110 may provide a camera, which will allows the user to preview the filters streaming live before and during the actual picture taking process. This important function allows the user to further amplify the professional look and quality effectively before the picture is taken.

Furthermore, the information sharing platform 110 may synchronize a new user's contacts with the web portal, when the information sharing platform 110 is downloaded for the first time. Once the user's information is recognized in the server, it will immediately assess who that user's friends and family are and the server will ‘push’ the user's friends and family public photos from the web portal onto the home screen of the information sharing platform 110 on the mobile application giving the user an instant position of recognition and user friendly comfort, as pictures of their friends and family will be viewable to greet the new user with their initial interaction.

As viewed in FIG. 5, with continued reference to FIGS. 1-4, the information sharing platform 110 also possesses an industry leading search capability 260 for searching out messages. This function allows the user to conduct a search through any type of message, whether; SMS, MMS 220, Email 240, Social 250, and Data 230, through the functionality of one simple and swift search interface. This powerful search function 260 the information sharing platform 110 offers is extremely revolutionary with its capability of searching for a message when the user does not remember the type of medium the message was communicated through. This cutting edge search tool supports communication record keeping and retrieval for both business and personal usage to become very simple and manageable with the information sharing platform's 110 advanced operating framework.

The remote server 200, which may host the information sharing platform 110 may include servers dedicated to hosting medium applicable for use within the information sharing platform 110. For example, the information sharing platform 110 may be hosted by Amazon Corporation Servers. Usage is made of these servers: EC2-Elastic Cloud, Infinitely Expanding Servers; RDS-Relational Data Base Service, and; S3-Storage Device, used for photo and video storage, as required. Any definitive plans for alternative server usage will be reviewed as requirement dictates what will be most effective for the information sharing platform 110.

Aggregation of messaging can occur in a number of ways, but in an embodiment, such aggregation is executed as follows.

Acquisition—The communication data required is acquired through normal channels (e.g., text, email, etc.) or other means necessary and is held for aggregation. The communication protocols may be any of the following, or others: SMS, MMS, RCS, Email, Data messaging, Social messaging, Video messaging (transcribed using voice recognition), Voice Messages (transcribed using voice recognition), Group messaging, etc.

Aggregation—Aggregating the communication data accounts for the differences between communication protocols. In order to make this aggregation possible, the communication metadata parts are reduced down to the lowest common denominator (LCD). The lowest common denominator would be, for example, the recipient's phone number(s), the sender's phone number, and the message in text format, later known and mentioned as LCD. LCD is based upon SMS metadata since it is the simplest form and the most widely employed throughout the world. Therefore using it as the base for the LCD allows both the simplest metadata and a fall back protocol for sending. Other protocols may be used as a base for the LCD, however in this particular use case SMS is deemed the most effective.

In some cases LCD metadata may not be obtained in its direct format from the communication protocols metadata. For example, email does not contain phone numbers within its metadata. Therefore in the event that the communication protocol does not contain the LCD metadata several actions may occur. The first action is to check a compiled contact list for a cross reference to obtain the phone numbers needed for LCD. The next action is to check the device's contact list to find a cross reference to obtain a phone number to meet the LCD requirements. The last action is to contact a server maintaining a larger and more heavily cross-referenced list of contacts shared amongst all users of the aggregation product to obtain the phone number to meet the LCD requirements.

In the event a cross reference cannot be found, the message will ultimately be disassociated for the particular conversation thread by LCD rules to which this conversation message should be assigned if any, therefore creating a new conversation thread.

In many cases the communication protocol will contain parts of any particular message sometimes known attachments. If parts or attachments are included in this particular message they will be saved to storage memory with its location stored in the database with a reference to the LCD message itself.

Contextual Conversation Threading Rule—Aggregation follows the rule that a conversation thread only ever includes the same originating members. As in human conversation; in real life, if Joe and Sally were talking and Jeff walked into the group, Joe and Sally would dynamically change their conversation to ensure it conforms to Jeff as well. Some things would go unsaid while other things said would be in a different tone.

Therefore by following this rule, communication context is always ensured. Special conditions must be considered in each different protocol, for example but not limited to: Email TO and CC (Carbon Copy) recipients would be required to be added as members of the message and therefore will be included in the conversation thread, however BCC (Blind Carbon Copy) recipients would need to require a new LCD conversation thread to be created between each BCC recipient and the sender because the members of the original conversation thread are not aware of the existence of the BCC recipient and therefore their conversation would continue without the knowledge of BCC and should not include BCC.

Execution—Once aggregated the conversation threads can easily be sorted and searched to be displayed to the user in the most appropriate fashion to suit the user interface.

Outgoing path discrimination—Due to the unique nature of the message aggregation described herein, messages may be received via any of the included communication protocols. This may cause a problem in responding to the other party in the particular conversation thread. To solve this, the last communication protocol that was used by the other party is selected in order to reply or communicate within the conversation thread. A multiple stop switch on the user interface in an embodiment allows the user to override the default selected protocol. This usage allows for full communication between the members of this conversation thread regardless if one or the other have message aggregation installed or not and allows for the most fluid conversation possible.

Feature propagation—Due to the unique nature of the described Multi Messaging system, available features in one protocol that are not common amongst other protocols can be introduced with high efficiency and exciting results. For example, SMS/MMS messages can be marked as read/unread (as in an Email solution), stickers can be introduced into MMS and even Email (as in a social solution) and GIF animations can be introduced into MMS and even Email (as in a social solution). These are simply examples, and any other number of protocol cross pollinations may occur.

Installations—Due to the unique nature of the described system, there is no requirement for both parties to have the system installed. Since the well-established solution of SMS follows the LCD requirements, this means that in the case the recipient does not have the system installed (as indicated in the system's server user base), the message can still be delivered by SMS at the very least. Depending on the contact information know about the recipient, multiple other sending paths may be acceptable as well.

### INDUSTRIAL APPLICABILITY

From the foregoing, it may be appreciated that the information sharing platform disclosed herein may have industrial applicability in a variety of settings such as, but not limited to, personal use within a user's smartphone or other personal electronic device. Alternatively, the information sharing platform may be used by business or corporate entities which use the multiple communication services the information sharing platform is configured to connect. The envisioned information sharing platform may produce a common access and transmission point for multiple mobile applications to connect a plethora of users together through the communication offered by the information sharing platform. Such a common interface offered by the information sharing platform would reduce the need of a user or business to operate multiple access and communication programs simultaneously while aiding in the organization and dissemination of data to outside recipients.

While the foregoing detailed description has addressed only specific embodiments, it is to be understood that the scope of the disclosure is not intended to be limiting. Thus, the breadth and spirit of this disclosure is intended to be broader than any of the embodiments specifically disclosed and/or encompassed within the claims appended hereto.

1. A multi-messaging information sharing platform for exchanging information between users, the information sharing platform comprising:
a mobile application being a non-transitory storage medium stored within a memory of a personal electronic device of a user;
a secondary application being stored within the memory of the personal electronic device of the user;
an integration architecture, the integration architecture being able to access the memory and internal components of the personal electronic device and connect the secondary application to be accessed within the mobile application; and
a common multi-messaging screen, the common multi-messaging screen providing the user an interface upon which the user may send and receive information through either the mobile application or the secondary application by accessing the internal components of the personal electronic device to send and receive such information.

2. The multi-messaging information sharing platform according to claim 1, wherein the common multi-messaging screen provides the user the opportunity to send and receive a message through either a data message, a SMS message, an RCS message, a social message, or an email.

3. The multi-messaging information sharing platform according to claim 1, further comprising a plurality of modules including a data messaging module, social module, Email module, SMS/MMS/RCS module, and each of the plurality of modules further include a geographical location identifying a context of a conversation being held within the information sharing platform.

4. The multi-messaging information sharing platform according to claim 1, wherein a synchronization architecture allowing a user to synchronize information contained within the memory of the personal electronic device relating to the mobile application with a remote server operable to host the information received by the mobile application.

5. The multi-messaging information sharing platform according to claim 1, wherein the common multi-messaging screen further provides a slide selector, the slide selector being able to select a means of transmission for the mobile application in regards to the information being sent and received by the mobile application.

6. The multi-messaging information sharing platform according to claim 1, wherein the common multi-messaging screen further provides a multi-message search option, the multi-message search option able to access the memory of the personal device as well as a remote server to search information saved within either the memory of the personal device or the remote server to locate and retrieve a result of a search query.

7. An multi-messaging information sharing platform for exchanging information between users, the information sharing platform comprising:
a mobile application being a non-transitory storage medium stored within a memory of a personal electronic device of a user;
a secondary application being stored within the memory of the personal electronic device of the user;
an integration architecture, the integration architecture being able to access the memory and internal components of the personal electronic device and connect the secondary application to be accessed within the mobile application;
a connectivity architecture configured to use name identification for a communication between users, and the connectivity architecture being configured to direct and display the communication by a contact list of the user; and
a common multi-messaging screen, the common multi-messaging screen providing the user an interface upon which the user may send and receive information through either the mobile application or the secondary application by accessing the internal components of the personal electronic device to send and receive such information and the interface of the common multi-messaging screen displays information sent or received by the contact list of the user or by telephone number.

8. The multi-messaging information sharing platform according to claim 7, wherein the common multi-messaging screen provides the user the opportunity to send and receive a message through either a data message, a SMS message, an RCS message, a social message, or an email.

9. The multi-messaging information sharing platform according to claim 7, further comprising a plurality of modules including a data messaging module, social module, Email module, and SMS/MMS/RCS module, and each of the plurality of modules further include a geographical location identifying a context of a conversation being held within the information sharing platform.

10. The multi-messaging information sharing platform according to claim 7, wherein a synchronization architecture allowing a user to synchronize information contained within the memory of the personal electronic device relating to the mobile application with a remote server operable to host the information received by the mobile application.

11. The multi-messaging information sharing platform according to claim 7, wherein the common multi-messaging screen further provides a slide selector, the slide selector being able to select a means of transmission for the mobile application in regards to the information being sent and received by the mobile application.

12. The multi-messaging information sharing platform according to claim 7, wherein the common multi-messaging screen further provides a multi-message search option, the multi-message search option able to access the memory of the personal device as well as a remote server to search information saved within either the memory of the personal device or the remote server to locate and retrieve a result of a search query.
